(19) United States
(12) Patent Application Publication
(10) Pub. No.: US 2019/0033019 A1
(43) Pub. Date: Jan. 31, 2019

(54) ALUMINUM PLATE AND COOLER HAVING THE SAME

(71) Applicants: Hyundai Motor Company, Seoul (KR); Kia Motors Corporation, Seoul (KR)

(72) Inventors: Dong Young Lee, Goyang-si (KR); Seok Ha, Seoul (KR); Sung II Yoon, Seoul (KR); Tae Ho Jeong, Yongin-si (KR)

(73) Assignees: Hyundai Motor Company, Seoul (KR); Kia Motors Corporation, Seoul (KR)

(21) Appl. No.: 15/833,865

(22) Filed: Dec. 6, 2017

(30) Foreign Application Priority Data
Jul. 28, 2017 (KR) 10-2017-0095910

(51) Int. Cl. F28F 19/06; F28F 21/08

(52) U.S. Cl. CPC F28F 19/06; F02M 26/29; F28F 21/084

(57) ABSTRACT

An aluminum plate and an EGR cooler may include a cooler which cools exhaust gas recirculating from exhaust sides to intake sides may include a housing in which an internal space is formed, tubes disposed inside the housing at a predetermined interval, and pins disposed inside the tubes and of which one side contacts with internal surface of the tubes, wherein coolant flows between the housing and the tubes, and the exhaust gas flows inside the tubes and wherein the tubes or the pins may be aluminum alloy and include Mg and Ti with a predetermined ratio.

### CROSS-REFERENCE(S) TO RELATED APPLICATIONS

The present application claims priority to Korean Patent Application No. 10-2017-0095910, filed on Jul. 28, 2017, the entire contents of which are incorporated herein for all purposes by this reference.

### BACKGROUND OF THE INVENTION

### Field of the Invention

The present invention relates to an exhaust gas recirculation (EGR) cooler, and, more particularly, the present invention relates to an EGR which recirculates exhaust gas from an exhaust line to an intake line for decreasing a nitrogen oxide and a granular material generated in the exhaust gas, and cools the recirculated exhaust gas, and an aluminum plate used therein.

### Description of Related Art

Recently, as an environment problem, including global warming, has emerged, regulations on exhaust gas of an automobile become stricter, and, a strict standard is applied to an emission quantity of the exhaust gas of a vehicle.

Particularly, under the EURO-6 standard, in a case of a diesel engine for a vehicle, the quantity of NOₓ generated needs to be decreased to a level of 80 mg/km, and in the present respect, the vehicle related companies have adopted new technologies, including an EGR, an LNT, and an SCR.

The exhaust gas recirculation (EGR) device includes a high pressure exhaust gas recirculation (HP-EGR) device, which recirculates exhaust gas and mixes the recirculated exhaust gas with compressed air, and a low pressure exhaust gas recirculation (LP-EGR) device, which recirculates exhaust gas at a rear end portion of a diesel particle filter (DPF) and mixes the recirculated exhaust gas with air at a front end portion of a turbo charger.

In the present case, to cool the recirculated exhaust gas, an EGR cooler is disposed in an exhaust gas recirculation line, and the EGR cooler includes a stainless material having high corrosion resistivity to a high temperature state and condensate water.

However, the EGR cooler including the stainless material is heavy, has low heat transfer efficiency, and has a poor molding property, thus the components are expensive. Accordingly, research on an EGR cooler, which has high heat transfer efficiency, has an excellent molding property, and includes aluminum, and of which components are relatively cheap, has been conducted.

Typically, A1100 which is based on pure aluminum (A1XXX) and A3003 which is based on aluminum-manganese (A3XXX) are used in a pin and a tube of a heat exchanger, which is configured as a cooler, and a temperature of the recirculated exhaust gas is approximately 550° C.

Furthermore, corrosive ions, including Cl⁻, SO₄²⁻, and NO₃⁻, exists as a component of condensate water, wherein the aluminum-based pin or tube may be damaged in a high temperature environment and a corrosive environment. In present respect, research on an aluminum sheet having high strength and high corrosion resistivity is conducted.

The information disclosed in this Background of the Invention section is only for enhancement of understanding of the general background of the invention and should not be taken as an acknowledgement or any form of suggestion that this information forms the prior art already known to a person skilled in the art.

### BRIEF SUMMARY

Various aspects of the present invention are directed to providing an aluminum plate, which maintains a strength and has high corrosion resistivity in an environment, in which corrosive ions, including Cl⁻, SO₄²⁻, and NO₃⁻, exists as the components of condensate water, and a temperature of recirculated exhaust gas is approximately 550° C., and an EGR cooler including the same.

According to an exemplary embodiment of the present invention, a cooler may include a housing in which internal space is formed, tubes disposed inside the housing with a predetermined interval, and pins disposed inside the tubes and of which one side contacts with internal surface of the tubes. The tubes or the pins may be an aluminum alloy and include at least one material selected from Mg, Cr and Ti with a predetermined ratio.

The tubes or the pins may include a cladding layer formed on a surface layer of an external side of the tube, and a core layer disposed internally to the cladding layer, and the core layer may include Mg, Cr, and Ti with a predetermined ratio.

The core layer may include Cu, Si, Fe, Zn, Mg, Cr, Mn, Ti, and Al.

The core layer may include 0.43 to 0.57 wt % of Cu, a maximum of 0.15 wt % of Si, 0.36 to 0.48 wt % of Fe, a maximum of 0.50 wt % of Zn, 0.20 to 0.32 wt % of Mg, a maximum of 0.05 wt % of Cr, 0.90 to 1.10 wt % of Mn, 0.13 to 0.20 wt % of Ti, and the remaining ratio of Al.

An aluminum plate according to an exemplary embodiment of the present invention may be aluminum alloy and may include at least one material selected from Mg, Cr and Ti with a predetermined ratio.

The aluminum plate may include a cladding layer formed on a surface layer of which an external side of the aluminum plate, and a core layer disposed internal to the cladding layer, wherein the core layer may include Mg, Cr, and Ti with a predetermined ratio.

The core layer may include Cu, Si, Fe, Zn, Mg, Cr, Mn, Ti, and Al.

The core layer may include 0.43 to 0.57 wt % of Cu, a maximum of 0.15 wt % of Si, 0.36 to 0.48 wt % of Fe, a maximum of 0.50 wt % of Zn, 0.0.20 to 0.32 wt % of Mg, a maximum of 0.05 wt % of Cr, 0.90 to 1.10 wt % of Mn, 0.13 to 0.20 wt % of Ti, and the remaining ratio of Al.

According to the exemplary embodiments of the present invention, the aluminum plate has a higher strength and an improved corrosion resistivity at a high temperature and in an environment, in which corrosive ions exist, than those of a general aluminum plate of A3003 by improving the material characteristic of aluminum used in tubes and pins of the EGR cooler.

Furthermore, the EGR cooler using the aluminum plate may decrease a weight thereof by the material characteristic of the aluminum, improve a heat exchange efficiency, and have a relatively high strength and high corrosive resistive characteristic to improve marketability and durability.

In the exemplary embodiment of the present invention, it is possible to expect an age-hardening effect by an extraction of MgSi by adding a magnesium (Mg) ingredient to the aluminum plate, and general strength of the core layer may be improved by an extraction of Al₁₂(Fe,Mn)3Si fine dispersoid and Al₂Cu by increasing the contents of Si and Cu.

Furthermore, it is possible to improve corrosion resistivity by adding an ingredient of Ti, and the addition of the ingredient of Ti to the aluminum alloy may change a corrosion progression from a localized corrosion to a lateral corrosion, effectively restricting through-corrosion.

Furthermore, Cr suppresses corrosion of grain boundaries.

The methods and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

FIG. 1 is a cross-sectional view of one side of an EGR cooler according to an exemplary embodiment of the present invention;

FIG. 2 is a schematic cross-sectional view of an aluminum plate used in an EGR cooler according to an exemplary embodiment of the present invention;

FIG. 3 is a table representing ingredients of an aluminum plate according to an exemplary embodiment of the present invention;

FIG. 4 is a graph representing a characteristic of an aluminum plate according to an exemplary embodiment of the present invention;

FIG. 5 is a table representing corrosion potential of an aluminum plate according to an exemplary embodiment of the present invention; and

FIG. 6 is a picture representing a result of a dipping measurement of an aluminum plate according to an exemplary embodiment of the present invention.

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in portion by the particular intended application and use environment.

In the figures, reference numbers refer to the same or equivalent portions of the present invention throughout the several figures of the drawing.

### DETAILED DESCRIPTION

Reference will now be made in detail to various embodiments of the present invention(s), examples of which are illustrated in the accompanying drawings and described below. While the invention(s) will be described in conjunction with exemplary embodiments, it will be understood that the present description is not intended to limit the invention(s) to those exemplary embodiments. On the other hand, the invention(s) is/are intended to cover not only the exemplary embodiments, but also various alternatives, modifications, equivalents and other embodiments, which may be included within the spirit and scope of the invention as defined by the appended claims.

Furthermore, the size and thickness of each configuration shown in the drawings are arbitrarily shown for understanding and ease of description, but the present invention is not limited thereto, and the thickness of layers, films, panels, spaces, etc., are exaggerated for clarity.

A part irrelevant to the description will be omitted to clearly describe the exemplary embodiment of the present invention.

In the following description, dividing names of components into first, second and the like is to divide the names because the names of the components are the same as each other and an order thereof is not particularly limited.

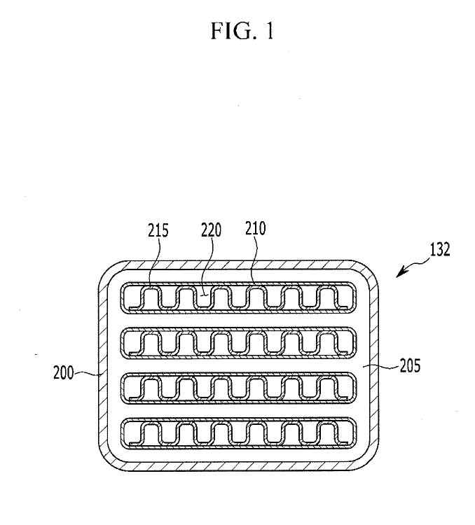

FIG. 1 is a cross-sectional view of one side of an EGR cooler according to an exemplary embodiment of the present invention.

Referring to FIG. 1, the EGR cooler 132 may include a housing 200, tubes 210, and pins 215.

An internal space is formed inside the housing 200, and the tubes 210 are disposed internally to the housing 200 from an upper portion to a lower portion of the housing 200 with a predetermined interval, and the pin 215 having a zig-zag shape is disposed internally to the tube 210.

An upper side of the pin 215 is brazed to an upper surface of an internal side of the tube 210, a lower side of the pin 215 is brazed to a lower surface of the internal side of the tube 210, and the pin 215 improves heat transfer efficiency between the recirculated exhaust gas and the coolant.

A coolant path 205, in which a coolant flows, is formed between an external surface of the tube 210 and the internal surface of the housing 200, an exhaust gas path 220, through which recirculated exhaust gas passes, is formed inside the tube 210, and the recirculated exhaust gas is cooled by the coolant by the pin 215 and the tube 210.

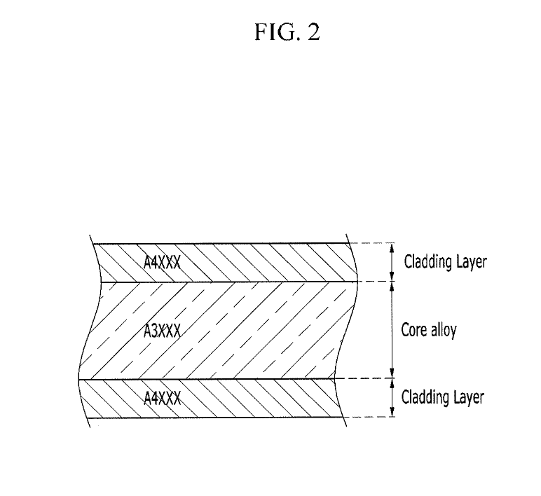

FIG. 2 is a schematic cross-sectional view of an aluminum plate used in the EGR cooler according to the exemplary embodiment of the present invention.

Referring to FIG. 2, the tube 210 is generally formed of three layers, and may include a core layer at a center thereof, and cladding layers formed on both surfaces of the core layer.

An A3XXX-based aluminum alloy is used in the core layer, and an A4XXX-based aluminum alloy is used in the cladding layer.

In the exemplary embodiment of the present invention, it is possible to expect an age-hardening effect by an extraction of MgSi by adding a magnesium (Mg) ingredient to the core layer, and the general strength of the core layer may be improved by an extraction of Al₁₂(Fe,Mn)3Si fine dispersoid and Al₂Cu by increasing the contents of Si and Cu.

Furthermore, it is possible to improve the corrosion resistivity by adding an ingredient of Ti, and the addition of the ingredient of Ti to the aluminum alloy may change a corrosion progression from a localized corrosion to a lateral corrosion, effectively restricting through-corrosion.

Furthermore, Cr suppresses corrosion of grain boundaries. Here, the corrosion of grain boundaries is inter-granular corrosion, and means corrosion generated along grain boundaries.

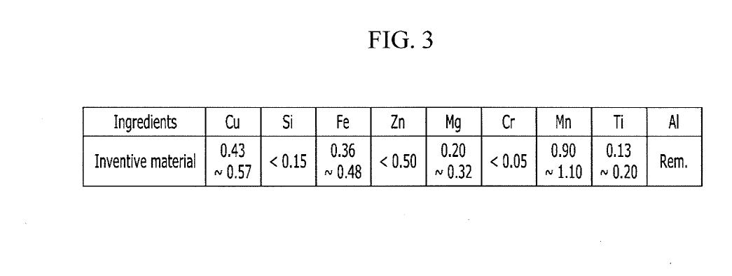

FIG. 3 is a table representing ingredients of the aluminum plate according to the exemplary embodiment of the present invention.

Referring to FIG. 3, the core layer of the pins 215 or the tubes 210 used in the EGR cooler 132 may include 0.43 to 0.57 wt % of Cu, a maximum of 0.15 wt % of Si, 0.36 to 0.48 wt % of Fe, a maximum of 0.50 wt % of Zn, 0.20 to 0.32 wt % of Mg, a maximum of 0.05 wt % of Cr, 0.90 to 1.10 wt % of Mn, 0.13 to 0.20 wt % of Ti, and the remaining ratio of Al.

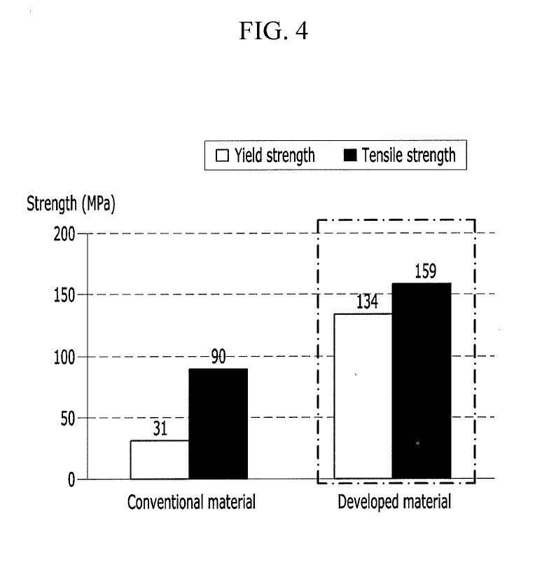

FIG. 4 is a graph representing a characteristic of the aluminum plate according to the exemplary embodiment of the present invention.

Referring to FIG. 4, the graph represents yield strength and tensile strength of a conventional material and a developed material. In a case of the conventional material, the yield strength and the tensile strength are 31 MPa and 90 MPa respectively, and in a case of the developed material, the yield strength and the tensile strength are 134 MPa and 159 MPa respectively.

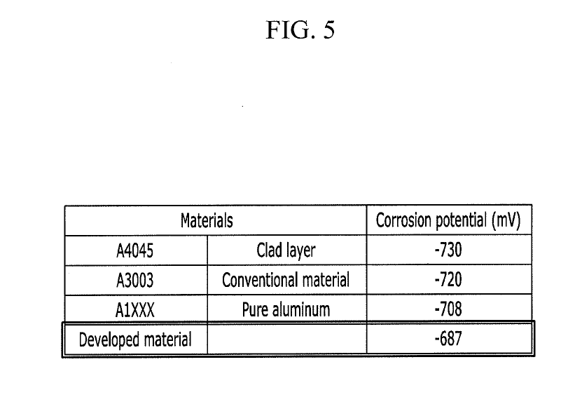

FIG. 5 is a table representing a corrosion potential of the aluminum plate according to the exemplary embodiment of the present invention.

Referring to FIG. 5, the table represents the corrosion potential of a respective material. The corrosion potential of A4045, which is used in the clad layer, is −730 mV, the corrosion potential of A3003, which is a conventional material, is −720 mV, and the corrosion potential of A1XXX, which is pure aluminum, is −708 mV.

Furthermore, the corrosion potential of the developed material is −687 mV. Accordingly, the developed material has a more improved resistivity to the corrosion than the conventional material.

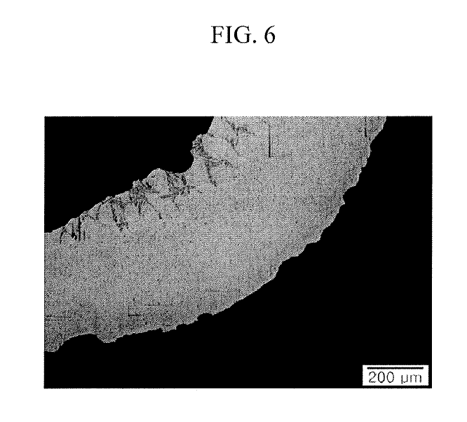

FIG. 6 is a picture representing a result of a dipping measurement of the aluminum plate according to the exemplary embodiment of the present invention.

Referring to FIG. 6, as a dipping result, the plate is not penetrated but entirely corroded with a predetermined depth.

The aluminum material according to the exemplary embodiment of the present invention may be applied to an aluminum EGR cooler including the tubes and the pins, and be applied to the core layer disposed inside the clad of the tubes and the pins.

Furthermore, the aluminum EGR cooler is used in the engine, and the engine may include an intake line, a turbo charger including a turbine and a compressor, an intercooler, a combustion chamber, an exhaust line, an EGR line, an EGR valve, an EGR cooler, and a controller.

Unexplained portions in the specification refer to known techniques.

In an exemplary embodiment of the present invention, a temperature of the exhaust gas circulating the EGR cooler is approximately 550° C., and condensate water is generated according to a temperature drop of the exhaust gas. The components of condensate water include corrosive ions include Cl⁻, SO₄²⁻, and NO₃⁻.

Accordingly, the aluminum plate has a higher strength and improved corrosion resistivity at a high temperature and in an environment, in which corrosive ions exist, than those of the general aluminum plate of A3003 by improving the material characteristic of aluminum used in tubes and pins of the EGR cooler.

Furthermore, the EGR cooler using the aluminum plate may decrease a weight thereof by the material characteristic of the aluminum, improve heat transfer efficiency, and have a relatively high strength and high corrosive resistive characteristic to improve marketability and durability.

In an exemplary embodiment of the present invention, while it is explained that the tubes 210 and the pins 215 are applied to the EGR cooler, in the other exemplary embodiment of the present invention, they may be applied to an intercooler cooling air oversupplied by a compressor of a turbo charger or a supercharger beside the EGR cooler.

Furthermore, the cooler according to an exemplary embodiment of the present invention may be applied to a heat exchanger transferring heat between two mediums, and the applying field is not limited thereto.

Furthermore, in an exemplary embodiment of the present invention, the EGR cooler may be applied to a low pressure EGR cooler and a high pressure EGR cooler of an engine, and may be selectively applied to heat exchangers transferring heat between at least two mediums which is included in a vehicle field.

For convenience in explanation and accurate definition in the appended claims, the terms “upper”, “lower”, “up”, “down”, “upwards”, “downwards”, “internal”, “outer”, “inside”, “outside”, “inwardly”, “outwardly”, “internal”, “external”, “front”, “rear”, “back”, “forwards”, and “backwards” are used to describe features of the exemplary embodiments with reference to the positions of such features as displayed in the figures.

The foregoing description of specific exemplary embodiments of the present invention has been presented for purposes of illustration and description. They are not intended to limit the invention to the precise forms disclosed, and obviously many modifications and variations are possible in light of the above teachings. The exemplary embodiments were chosen and described to explain certain principles of the invention and their practical application, to enable others skilled in the art to make and utilize various exemplary embodiments of the present invention, as well as various alternatives and modifications thereof. It is intended that the scope of the invention be defined by the Claims appended hereto and their equivalents.

What is claimed is:

1. A cooler apparatus, comprising:
a housing in which an internal space is formed;
tubes disposed inside the housing at a predetermined interval; and
pins disposed internal to the tubes and of which a first side contacts an internal surface of the tubes,
wherein the tubes or the pins are aluminum alloy and include at least one material selected from Mg, Cr and Ti with a predetermined ratio.

2. The cooler apparatus of claim 1, wherein
the tubes or the pins include a cladding layer formed on a surface layer of an external side of the tubes, and a core layer disposed internal to the cladding layer, wherein the core layer includes Mg, Cr, and Ti with a predetermined ratio.

3. The cooler apparatus of claim 2, wherein
the core layer includes Cu, Si, Fe, Zn, Mg, Cr, Mn, Ti, and Al.

4. The cooler apparatus of claim 3, wherein
the core layer includes 0.43 to 0.57 wt % of Cu, a maximum of 0.15 wt % of Si, 0.36 to 0.48 wt % of Fe, a maximum of 0.50 wt % of Zn, 0.20 to 0.32 wt % of Mg, a maximum of 0.05 wt % of Cr, 0.90 to 1.10 wt % of Mn, 0.13 to 0.20 wt % of Ti, and a remaining ratio of Al.

5. An aluminum plate which is aluminum alloy used in a cooler apparatus, including at least one material selected from Mg, Cr and Ti with a predetermined ratio.

6. The aluminum plate of claim 5, including:
a cladding layer formed on a surface layer of an external side of the aluminum plate; and
a core layer disposed inside the cladding layer,
wherein the core layer includes Mg, Cr, and Ti with a predetermined ratio.

7. The aluminum plate of claim 6, wherein
the core layer includes Cu, Si, Fe, Zn, Mg, Cr, Mn, Ti, and Al.

8. The aluminum plate of claim 7, wherein
the core layer includes 0.43 to 0.57 wt % of Cu, a maximum of 0.15 wt % of Si, 0.36 to 0.48 wt % of Fe, a maximum of 0.50 wt % of Zn, 0.20 to 0.32 wt % of Mg, a maximum of 0.05 wt % of Cr, 0.90 to 1.10 wt % of Mn, 0.13 to 0.020 wt % of Ti, and a remaining ratio of Al.
